(19) United States
(12) Patent Application Publication
(10) Pub. No.: US 2025/0164794 A1
(43) Pub. Date: May 22, 2025

(54) IMAGE LIGHT GUIDE SYSTEM WITH CROSSED IN-COUPLING OPTICS

(71) Applicant: Vuzix Corporation, West Henrietta, NY (US)

(72) Inventors: Robert J. Schultz, Victor, NY (US); Marek W. Kowarz, Henrietta, NY (US)

(21) Appl. No.: 18/867,760

(22) PCT Filed: May 19, 2023
(86) PCT No.: PCT/US2023/023006

§ 371 Date: Nov. 20, 2024

Related U.S. Application Data
(60) Provisional application No. 63/344,370, filed on May 20, 2022.

(51) Int. Cl. G02B 27/01; G02B 5/18; G02B 27/00

(52) U.S. Cl. CPC G02B 27/0172; G02B 5/1819; G02B 27/0081; G02B 2027/0125; G02B 2027/0178

(57) ABSTRACT

An image light guide for conveying a virtual image including a first surface and a parallel second surface, an in-coupling diffractive optic arranged along the first surface and/or the second surface, wherein the in-coupling diffractive comprises a first zone having a first set of diffractive features and a second zone having a second of diffractive features, and an out-coupling diffractive optic arranged along the first surface and/or the second surface, wherein the out-coupling diffractive optic comprises a first area having two or more zones and a second area having two or more zones. Wherein an imaginary axis is oriented along a centerline of the out-coupling diffractive optic, image-bearing light in-coupled into the waveguide by the first zone of the in-coupling diffractive optic is operable to propagate across the imaginary axis to the first area of the out-coupling diffractive optic, and image-bearing light in-coupled into the waveguide by the second zone of the in-coupling diffractive optic is operable to propagate across the imaginary axis to the second area of the out-coupling diffractive optic.

### TECHNICAL FIELD

The present disclosure generally relates to electronic displays, and more particularly to optical image light guide systems with diffractive optics operable to convey image-bearing light to a viewer.

### BACKGROUND

Head-Mounted Displays (HMDs) are being developed for a range of diverse uses, including military, commercial, industrial, fire-fighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

In general, HMD optics must meet a number of basic requirements for viewer acceptance, including pupil size and field of view (FOV). Pupil size requirements are based on physiological differences in viewer face structure as well as on gaze direction during viewing. A minimum entrance pupil diameter of approximately 10 mm has been found to be desirable for general viewers. A wide FOV is preferable for many tasks and operations. Further, the virtual image that is generated should have sufficient brightness for visibility and viewer comfort.

In addition to optical requirements, HMD designs must also address practical factors such as acceptable form factor with expectations of reduced size for wearing comfort, weight, cost, and ease of use. There is thus a need for an image light guide system providing an increased FOV and brightness while maintaining a small form factor.

### SUMMARY

It is an object of the present disclosure to advance the art of virtual image presentation using head-mounted devices. Advantageously, embodiments of the present disclosure provide light coupling solutions that are compatible with the general form factor of eyeglasses.

These and other aspects, objects, features and advantages of the present invention will be more clearly understood and appreciated from the following detailed description of the embodiments and appended claims, and by reference to the accompanying drawings. In a first exemplary embodiment, the present disclosure provides an image light guide for conveying a virtual image including a first surface and a parallel second surface, an in-coupling diffractive optic arranged along the first surface and/or the second surface, wherein the in-coupling diffractive comprises a first zone having a first set of diffractive features and a second zone having a second of diffractive features, and an out-coupling diffractive optic arranged along the first surface and/or the second surface, wherein the out-coupling diffractive optic comprises a first area having two or more zones and a second area having two or more zones. Wherein an imaginary axis is oriented along a centerline of the out-coupling diffractive optic, and wherein image-bearing light in-coupled into the waveguide by the first zone of the in-coupling diffractive optic is operable to propagate across the axis to the first area of the out-coupling diffractive optic, and wherein image-bearing light in-coupled into the waveguide by the second zone of the in-coupling diffractive optic is operable to propagate across the axis to the second area of the out-coupling diffractive optic.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a top view of an image light guide with an exaggerated thickness for showing the propagation of light from an image source along the image light guide to an eyebox within which the virtual image can be viewed.

FIG. 2 is a perspective view of an image light guide including an in-coupling diffractive optic, a turning diffractive optic, and out-coupling diffractive optic for managing the propagation of image-bearing light beams.

FIG. 3 is a side view of an image light guide according to an exemplary embodiment of the presently disclosed subject matter.

FIG. 4A is a top view of an embodiment of the image light guide, with an exaggerated thickness, according to FIG. 3.

FIG. 4B is a top view of another embodiment of the image light guide, with an exaggerated thickness, according to FIG. 3.

FIG. 4C is a top view of yet another embodiment of the image light guide, with an exaggerated thickness, according to FIG. 3.

FIG. 5 is a side view of an embodiment of an in-coupling diffractive optic according to FIG. 3.

FIG. 6A is a detail view of area 6 of FIG. 3 according to an exemplary embodiment of the presently disclosed subject matter.

FIG. 6B is a detail view of area 6 of FIG. 3 according to an exemplary embodiment of the presently disclosed subject matter.

FIG. 7 is a schematic top view of an image light guide system according to an exemplary embodiment of the presently disclosed subject matter.

FIG. 8 is a side view of the image light guide according to FIG. 7.

FIG. 9 is a schematic of the angular bandwidth of a wavelength of image-bearing light emitted by an image source.

FIG. 10 is a perspective view of an image light guide according to an exemplary embodiment of the presently disclosed subject matter.

FIG. 11A is a side view of a first surface of the image light guide according to FIG. 10.

FIG. 11B is a side view of a second surface of the image light guide according to FIG. 10.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, and “user” are considered equivalents and refer to the person, or machine, that wears and/or views images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling” in the context of optics refer to a connection by which light travels from one optical medium or device to another optical medium or device.

Where used herein, the terms “wavelength band” and “wavelength range” are equivalent and have their standard connotation as used by those skilled in the art of color imaging and refer to a continuous range of light wavelengths that are used to represent polychromatic images.

Where used herein, the term “beam expansion” is intended to mean replication of a beam via multiple encounters with an optical element to provide exit pupil expansion in one or more dimensions. Similarly, as used herein, to “expand” a beam, or a portion of a beam, is intended to mean replication of a beam via multiple encounters with an optical element to provide exit pupil expansion in one or more dimensions.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

An optical system, such as a HMD, can produce a virtual image. In contrast to methods for forming a real image, a virtual image is not formed on a display surface. That is, if a display surface were positioned at the perceived location of a virtual image, no image would be formed on that surface. Virtual images have a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

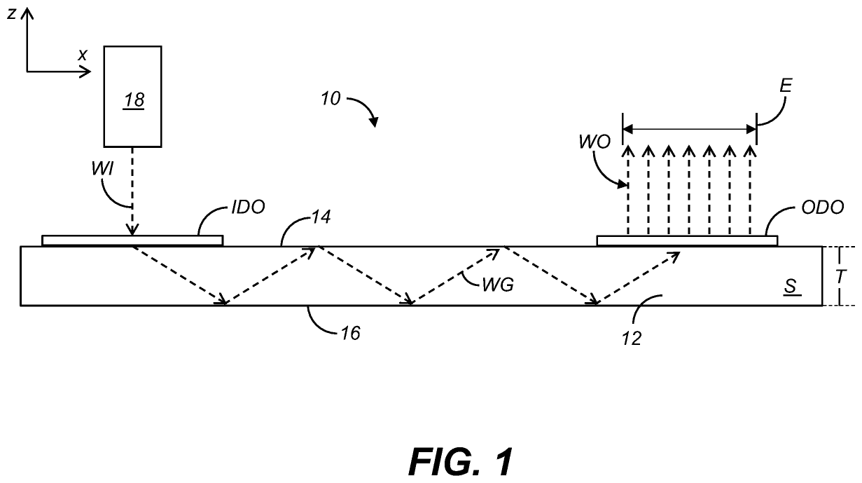

FIG. 1 is a schematic diagram showing a simplified cross-sectional view of one conventional configuration of an image light guide system 10. Image light guide system 10 includes a planar image light guide 12, an in-coupling diffractive optic IDO, and an out-coupling diffractive optic ODO. The image light guide 12 includes a transparent substrate S, which can be made of optical glass or plastic, with plane-parallel front and back surfaces 14 and 16. In this example, the in-coupling diffractive optic IDO is shown as a transmissive-type diffraction grating arranged on, in, or otherwise engaged with the front surface 14 of the image light guide 12. However, in-coupling diffractive optic IDO could alternately be a reflective-type diffraction grating or other type of diffractive optic, such as a volume hologram or other holographic diffraction element, that diffracts incoming image-bearing light beams WI into the image light guide 12. The in-coupling diffractive optic IDO can be located on, in, or otherwise engaged with front surface 14 or back surface 16 of the image light guide 12 and can be of a transmissive or reflective-type in a combination that depends upon the direction from which the image-bearing light beams WI approach the image light guide 12.

When used as a part of a near-eye or head-mounted display system, the in-coupling diffractive optic IDO of the conventional image light guide system 10 couples the image-bearing light beams WI from a real, virtual or hybrid image source 18 into the substrate S of the image light guide 12. Any real image or image dimension formed by the image source 18 is first converted into an array of overlapping, angularly related, collimated beams encoding the different positions within a virtual image for presentation to the in-coupling diffractive optic IDO. Typically, the rays within each bundle forming one of the angularly related beams extend in parallel, but the angularly related beams are relatively inclined to each other through angles that can be defined in two angular dimensions corresponding to linear dimensions of the image.

Once the angularly related beams engage with the in-coupling diffractive optic IDO, at least a portion of the image-bearing light beams WI are diffracted (generally through a first diffraction order) and thereby redirected by in-coupling diffractive optic IDO into the planar image light guide 12 as angularly encoded image-bearing light beams WG for further propagation along a length dimension x of the image light guide 12 by total internal reflection (TIR) between the plane-parallel front and back surfaces 14 and 16. Although diffracted into a different combination of angularly related beams in keeping with the boundaries set by TIR, the image-bearing light beams WG preserve the image information in an angularly encoded form that is derivable from the parameters of the in-coupling diffractive optic IDO. The out-coupling diffractive optic ODO receives the encoded image-bearing light beams WG and diffracts (also generally through a first diffraction order) at least a portion of the image-bearing light beams WG out of the image light guide 12, as image-bearing light beams WO, toward a nearby region of space referred to as an eyebox E, within which the transmitted virtual image can be seen by a viewer's eye or other optical component. The out-coupling diffractive optic ODO can be designed symmetrically with respect to the in-coupling diffractive optic IDO to restore the original angular relationships of the image-bearing light beams WI among outputted angularly related beams of the image-bearing light beams WO. In addition, the out-coupling diffractive optic ODO can modify the original field points' positional angular relationships producing an output virtual image at a finite focusing distance.

However, to increase one dimension of overlap among the angularly related beams populating the eyebox E (defining the size of the region within which the virtual image can be seen), the out-coupling diffractive optic ODO is arranged together with a limited thickness T of the image light guide 12 to encounter the image-bearing light beams WG multiple times and to diffract only a portion of the image-bearing light beams WG upon each encounter. The multiple encounters along the length (e.g., a first direction) of the out-coupling diffractive optic ODO have the effect of replicating the image-bearing light beams WG and enlarging or expanding at least one dimension of the eyebox E where the replicated beams overlap. The expanded eyebox E decreases sensitivity to the position of a viewer's eye for viewing the virtual image.

The out-coupling diffractive optic ODO is shown as a transmissive-type diffraction grating arranged on or secured to the front surface 14 of the image light guide 12. However, like the in-coupling diffractive optic IDO, the out-coupling diffractive optic ODO can be located on, in, or otherwise engaged with the front or back surface 14 or 16 of the image light guide 12 and can be of a transmissive or reflective-type in a combination that depends upon the direction through which the image-bearing light beams WG is intended to exit the image light guide 12. In addition, the out-coupling diffractive optic ODO could be formed as another type of diffractive optic, such as a volume hologram or other holographic diffraction element, that diffracts propagating image-bearing light beams WG from the image light guide 12 as the image-bearing light beams WO propagating toward the eyebox E.

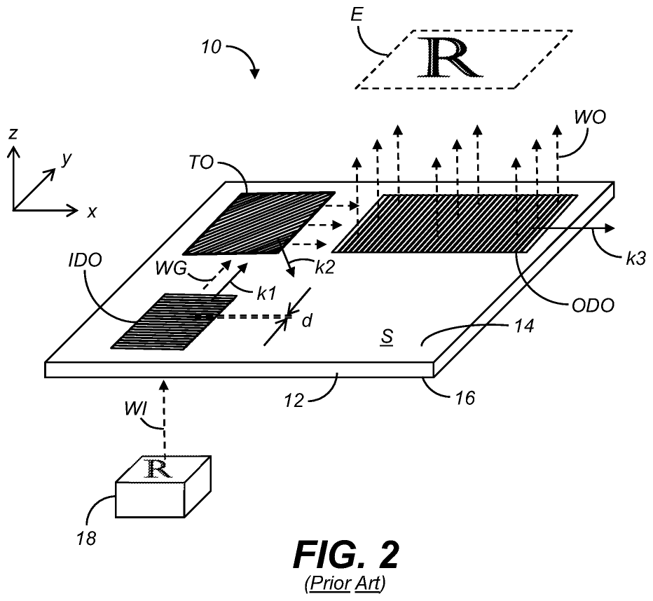

FIG. 2 illustrates a perspective view of a conventional image light guide system 10 arranged for expanding the eyebox E in two dimensions, i.e., along both x- and y-axes of the intended image. To achieve a second dimension of eyebox expansion, the in-coupling diffractive optic IDO is oriented to diffract at least a portion of image-bearing light beams WG along a grating vector k1 along the image light guide 12 toward an intermediate turning optic TO, whose grating vector k2 is oriented to diffract at least a portion of the image-bearing light beams WG in a reflective mode along the image light guide 12 toward the out-coupling diffractive optic ODO. It should be appreciated that only a portion of the image-bearing light beams WG are diffracted by each of the multiple encounters with intermediate turning optic TO, thereby laterally replicating each of the angularly related beams of the image-bearing light beams WG as they approach the out-coupling diffractive optic ODO. The intermediate turning optic TO redirects the image-bearing light beams WG toward the out-coupling diffractive optic ODO (having a grating vector k3) for longitudinally replicating the angularly related beams of the image-bearing light beams WG in a second direction before exiting the image light guide 12 as the image-bearing light beams WO. Grating vectors, such as the depicted grating vectors k1, k2, and k3, extend within a parallel plane of the image light guide 12 in respective directions that are normal to the diffractive features (e.g., grooves, lines, or rulings) of the diffractive optics and have respective magnitudes inverse to the period or pitch d (i.e., the on-center distance between the diffractive features) of the diffractive optics IDO, TO, and ODO.

As shown in FIG. 2, in-coupling diffractive optic IDO receives the incoming image-bearing light beams WI containing a set of angularly related beams corresponding to individual pixels or equivalent locations within an image generated by the image source 18, such as a projector. A full range of angularly encoded beams for producing a virtual image can be generated by a real display together with collimating optics or other optical components, by a beam scanner for more directly setting the angles of the beams, or by a combination such as a one-dimensional real display used with a scanner. In this configuration, the image light guide 12 outputs a replicated set of angularly related beams (replicated in two dimensions) by providing multiple encounters of the image-bearing light beams WG with both the intermediate turning optic TO and the out-coupling diffractive optic ODO in different orientations. In the depicted orientation of the image light guide 12, the intermediate turning optic TO provides eyebox expansion in a first dimension, e.g., the y-axis direction, and the out-coupling diffractive optic ODO provides a similar eyebox expansion in a second dimensions, e.g., the x-axis direction. The relative orientations and respective periods d of the diffractive features of the in-coupling optic IDO, intermediate turning optic TO, and out-coupling diffractive optic ODO provide for eyebox expansion in two dimensions while preserving the intended relationships among the angularly related beams of the image-bearing light beams WI that are output from the image light guide system 10 as the image-bearing light beams WO. It should be appreciated that the periods d of the in-coupling diffractive optic IDO, the intermediate turning optic TO, and the out-coupling diffractive optic ODO, can each include diffractive features having a common pitch d, where the common pitch d of each optic can be different.

In the configuration shown, while the image-bearing light beams WI input into the image light guide 12 are encoded into a different set of angularly related beams by the in-coupling diffractive optic IDO, the information required to reconstruct the image is preserved by accounting for the systematic effects of the in-coupling diffractive optic IDO. The intermediate turning optic TO, located in an intermediate position between the in-coupling and out-coupling diffractive optics IDO and ODO, can be arranged so that it does not induce significant changes to the encoding of the image-bearing light beams WG. As such, the out-coupling diffractive optic ODO can be arranged in a symmetric fashion with respect to the in-coupling diffractive optic IDO, e.g., including diffractive features sharing the same period d. Similarly, the period of the intermediate turning optic TO can also match the common period of the in-coupling and out-coupling diffractive optics IDO and ODO. Although the grating vector k2 of the intermediate turning optic TO is shown oriented at 45 degrees with respect to the other grating vectors, which remains a possible orientation, the grating vector k2 of the intermediate turning optic TO can be oriented at 60 degrees to the grating vectors k1 and k3 of the in-coupling and out-coupling diffractive optics IDO and ODO in such a way that the image-bearing light beams WG are turned 120 degrees. By orienting the grating vector k2 of the intermediate turning optic TO at 60 degrees with respect to the grating vectors k1 and k3 of the in-coupling and out-coupling diffractive optics IDO and ODO, the grating vectors k1 and k3 of the in-coupling and out-coupling diffractive optics IDO and ODO are also oriented at 60 degrees with respect to each other. By basing the grating vector magnitudes on the common pitch shared by the in-coupling, intermediate turning, and out-coupling diffractive optics IDO, TO, and ODO, the three grating vectors k1, k2, and k3 (as directed line segments) form an equilateral triangle and sum to a zero vector magnitude, which avoids asymmetric effects that could introduce unwanted aberrations including chromatic dispersion. Such asymmetric effects can also be avoided by grating vectors k1, k2, and k3 that have unequal magnitudes in relative orientations at which the three grating vectors k1, k2, and k3 sum to a zero vector magnitude.

In a broader sense, the image-bearing light beams WI that are directed into the image light guide 12 are effectively encoded by the in-coupling diffractive optic IDO, whether the in-coupling optic IDO uses gratings, holograms, prisms, mirrors, or some other mechanism. Any reflection, refraction, and/or diffraction of light that takes place at the input should be correspondingly decoded by the output to re-form the virtual image that is presented to the viewer. Whether any symmetries are maintained among the intermediate turning optic TO, the in-coupling optic IDO, and out-coupling diffractive optic ODO, or whether any change to the encoding of the angularly related beams of the image-bearing light beams WI takes place along the image light guide 12, the intermediate turning optic TO and the in-coupling and out-coupling diffractive optics IDO and ODO can be related so that the image-bearing light beams WO that are output from the image light guide 12 preserve or otherwise maintain the original or desired form of the image-bearing light beams WI for producing the intended virtual image.

As shown in FIG. 2, the letter “R” represents the orientation of the virtual image that is visible to the viewer whose eye is positioned within the eyebox E. As shown, the orientation of the letter “R” in the represented virtual image matches the orientation of the letter “R” as encoded by the image-bearing light beams WI. A change in the rotation about the z axis or angular orientation of incoming image-bearing light beams WI with respect to the x-y plane causes a corresponding symmetric change in rotation or angular orientation of outgoing light from out-coupling diffractive optic (ODO). From the aspect of image orientation, the intermediate turning optic TO simply acts as a type of optical relay, providing one dimension of eyebox expansion through replication of the angularly encoded beams of the image-bearing light beams WG along one axis (e.g., along the y-axis) of the image. Out-coupling diffractive optic ODO further provides a second dimension of eyebox expansion through replication of the angularly encoded beams along another axis (e.g., along the x-axis) while maintaining the original orientation of the virtual image encoded by the image-bearing light beams WI. The intermediate turning optic TO is typically a slanted or square grating or, alternately, can be a blazed grating and is typically arranged on one of the plane-parallel front and back surfaces of the image light guide 12. It should be appreciated that the representation of the virtual image “R” as created by an image source is comprised of infinitely focused light that requires a lens (e.g., the lens in the human eye) to focus the image so that the orientations discussed above can be detected.

Together, the in-coupling, turning, and out-coupling diffractive optics IDO, TO, and ODO preferably preserve the angular relationships among beams of different wavelengths defining a virtual image upon conveyance by image light guide 12 from an offset position to a near-eye position of the viewer. While doing so, the in-coupling, turning, and out-coupling diffractive optics IDO, TO, and ODO can be relatively positioned and oriented in different ways to control the overall shape of the image light guide 12 as well as the overall orientations at which the angularly related beams can be directed into and out of the image light guide 12.

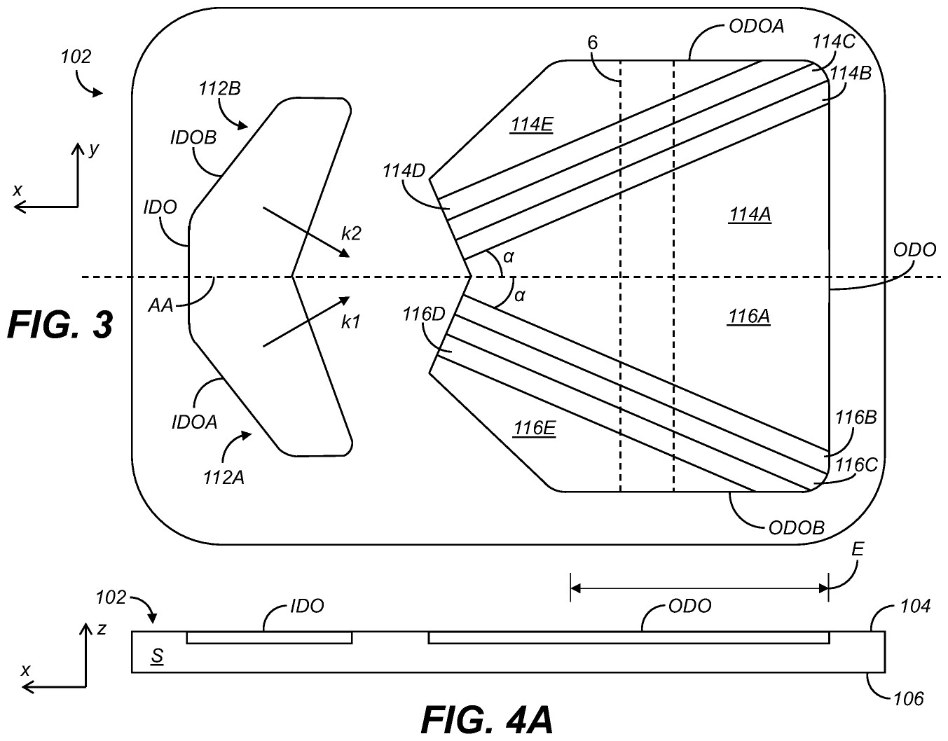

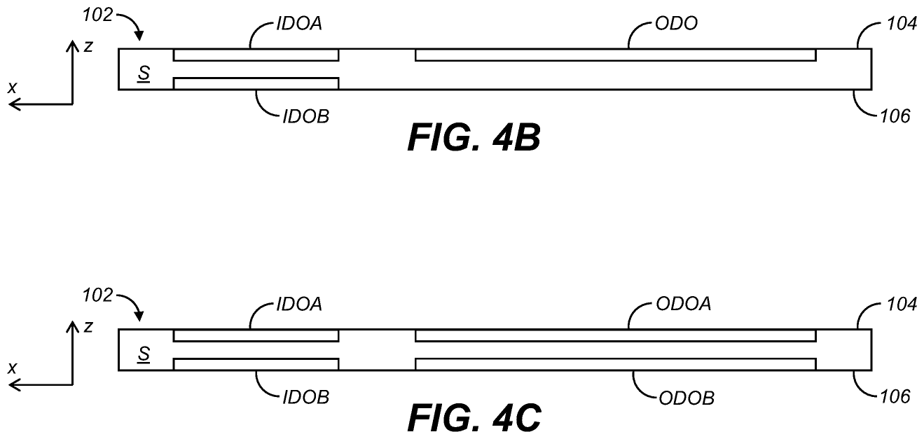

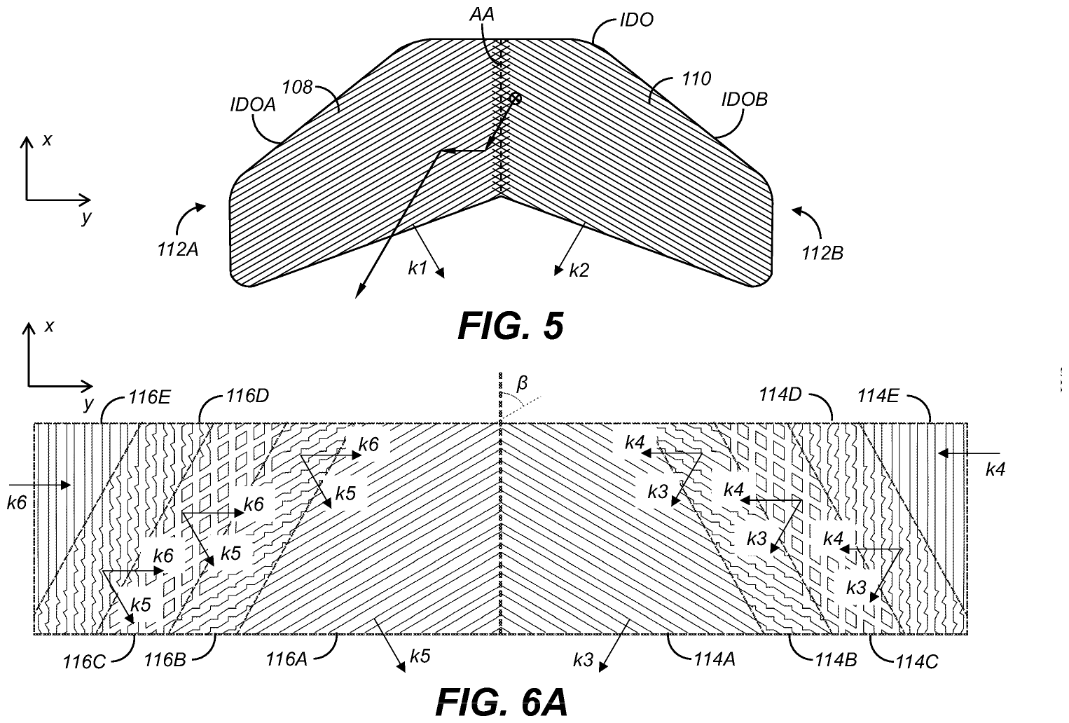

FIG. 3 shows an exemplary embodiment of a waveguide 102 according to the present disclosure. Referring now to FIGS. 3-5, in an example embodiment, the waveguide 102 includes an at least partially transparent substrate S, which can be made of optical glass or plastic, with plane-parallel front and back surfaces 104 and 106. The waveguide 102 includes an in-coupling diffractive optic IDO having a first zone IDOA and a second zone IDOB. As illustrated in FIG. 5, the first zone IDOA of the in-coupling diffractive optic IDO includes a first diffractive pattern 108 and the second zone IDOB of the in-coupling diffractive optic IDO includes a second diffractive pattern 110. The first diffractive pattern 108 includes a plurality of diffractive features periodic in at least a first direction expressed by the grating vector k1. The second diffractive patterns 110 includes another plurality of diffractive features periodic in at least a second direction expressed by the grating vector k2.

As illustrated in FIG. 5, in an example embodiment, the first and second diffractive patterns 108, 110 of the in-coupling diffractive optic IDO at least partially overlap at a centerline AA of the of the in-coupling diffractive optic IDO and the out-coupling diffractive optic ODO. The overlap of the first and second diffractive patterns 108, 110 of the in-coupling diffractive optic IDO produces a diffractive pattern of crossed diffractive features at, and adjacent to, the centerline AA. Additionally, the in-coupling diffractive optic IDO extends in the x-axis direction and the ±y-axis direction creating elongated portions 112A, 112B of the first and second zones IDOA, IDOB of the in-coupling diffractive optic IDO. The elongated portions 112A, 112B of the first and second zones IDOA, IDOB may also be referred to herein as wings. In an example embodiment where incoming image-bearing light beams WI are incident upon an area of the in-coupling diffractive optic IDO approximate, and adjacent to, the centerline AA, the wings 112A, 112B are operable to diffract light in-coupled by the respective laterally opposing grating patterns 108, 110 to turn a portion of in-coupled image-bearing light toward their original direction of propagation within the waveguide 102. An exemplary schematic ray tracing of this effect is shown in FIG. 5. Persons skilled in the relevant art will recognize that this ray tracing is illustrative of the principle and does not show every instance of diffraction of a ray incident upon the in-coupling diffractive optic IDO. This image-bearing light turning function of the wings 112A, 112B occurs upon an even numbered interaction of the image-bearing light with the respective wing 112A, 112B. Further, the turning function of the wings 112A, 112B facilitates expansion of the eyebox through replication of the image-bearing light in the y-axis direction.

Referring now to FIG. 3, in an example embodiment, the waveguide 102 includes an out-coupling diffractive optic ODO having a first area ODOA and a second area ODOB. The first area ODOA of the out-coupling diffractive optic ODO is optimized to diffract image-bearing light beams in-coupled by the first zone IDOA of the in-coupling diffractive optic IDO and the second area ODOB of the out-coupling diffractive optic ODO is optimized to diffract image-bearing light beams in-coupled by the second zone IDOB of the in-coupling diffractive optic IDO. Thus, image-bearing light beams in-coupled by the first zone IDOA of the in-coupling diffractive optic IDO cross an imaginary axis (hereinafter referred to as “axis”) collinear with the centerline AA of the of the in-coupling diffractive optic IDO and/or the out-coupling diffractive optic ODO before encountering the first area ODOA of the out-coupling diffractive optic ODO. Similarly, image-bearing light beams in-coupled by the second zone IDOB of the in-coupling diffractive optic IDO cross the axis collinear with the centerline AA of the of the in-coupling diffractive optic IDO before encountering the second area ODOB of the out-coupling diffractive optic ODO. In other words, the image-bearing light in-coupled into the waveguide by the first zone IDOA of the in-coupling diffractive optic IDO is operable to propagate across a path of the image-bearing light in-coupled into the waveguide by the second zone IDOB of the in-coupling diffractive optic IDO. For example, the original direction of propagation of image-bearing light in-coupled by the first zone IDOA is generally parallel with the grating vector k1 and the original direction of propagation of image-bearing light in-coupled by the second zone IDOB is generally parallel with the grating vector k2.

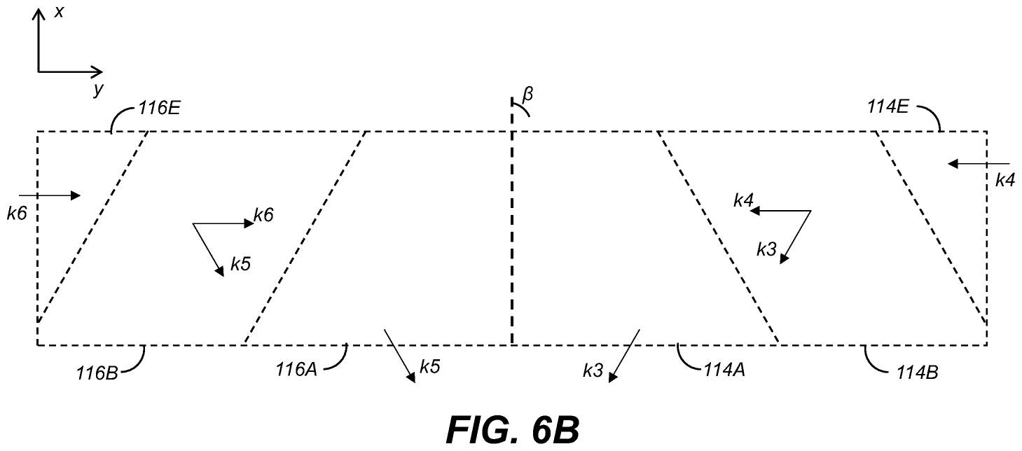

Referring now to FIGS. 3 and 6A, in an example embodiment, the first area ODOA of the out-coupling diffractive optic ODO includes a plurality of zones of diffractive features, e.g., a first zone 114A, a second zone 114B, a third zone 114C, a fourth zone 114D, and a fifth zone 114E of diffractive features, wherein the zones are arranged from the axis collinear with the centerline AA to the laterally outer edge of the out-coupling diffractive optic ODO in the +y-axis direction. In an example embodiment, the second, third, and fourth zones 114B, 114C, 114D are generally rectilinear adjacent parallel zones that are oriented at an angle α relative to the axis collinear with the centerline AA. The second, third, and fourth zones 114B, 114C, 114D separate the first and fifth zones 114A, 114E which have generally triangular shapes. The diffractive features of each zone 114A, 114B, 114C, 114D, 114E are different from the diffractive features in an adjacent zone 114A. 114B, 114C, 114D, 114E. In an example embodiment, the diffractive features of the first zone 114A approximate straight line diffractive features oriented at an angle β (shown in FIG. 6A) relative to the axis collinear with the centerline AA and the diffractive features of the fifth zone 114E approximate straight line diffractive features oriented generally parallel with the axis collinear with the centerline AA, while the diffractive features of the second, third, and fourth zones 114B, 114C, 114D progressively transition from the diffractive features of the first zone 114A to the diffractive features of the fifth zone 114E.

For example, as illustrated in FIG. 6A, the diffractive features of the second zone 114B may comprise a generally straight line diffractive feature parallel with the diffractive features of the first zone 114A and additionally having a periodic variation in the +x-axis direction generally parallel with the diffractive features of the fifth zone 114E. Continuing the example illustrated in FIG. 6, the diffractive features of the third zone 114C may comprise generally diamond-shaped posts having two sides generally parallel with the diffractive features of the first zone 114A and two sides generally parallel with the diffractive features of the fifth zone 114E. Each of the diffractive features of the fourth zone 114D may comprise a generally straight line diffractive feature parallel with the diffractive features of the fifth zone 114E and additionally have a periodic variation in the ±y-axis direction generally parallel with the diffractive features of the first zone 114A.

The periodicity of the diffractive features in the first zone 114A may be represented by a grating vector k3 and the periodicity of the diffractive features in the fifth zone 114E may be represented by a grating vector k4. The diffractive features of the second, third, and fourth zones 114B, 114C, 114D are periodic in at least two directions which may be represented by the grating vectors k3, k4.

With continued reference to FIGS. 3 and 6A, in an example embodiment, the second area ODOB of the out-coupling diffractive optic ODO includes a plurality of zones of diffractive features, e.g., a first zone 116A, a second zone 116B, a third zone 116C, a fourth zone 116D, and a fifth zone 116E of diffractive features, wherein the zones are arranged from the axis collinear with the centerline AA to the laterally outer edge of the out-coupling diffractive optic ODO in the (−)y-axis direction. In the illustrated embodiment, the zones 116A, 116B, 116C, 116D, 116E of diffractive features of the second area ODOB of the out-coupling diffractive optic ODO are arranged symmetric with the zones 114A, 114B, 114C, 114D, 114E of the first area ODOA of the out-coupling diffractive optic ODO, e.g., they are mirrored about the axis collinear with the centerline AA with respect to zones 114A, 114B, 114C, 114D, and 114E. The periodicity of the diffractive features in the first zone 116A may be represented by a grating vector k5 and the periodicity of the diffractive features in the fifth zone 116E may be represented by a grating vector k6. The diffractive features of the second, third, and fourth zones 116B, 116C, 116D are periodic in at least two directions which may be represented by the grating vectors k5, k6. In an exemplary embodiment, the grating vector k1 is parallel to the grating vector k5, and the grating vector k2 is parallel to the grating vector k3. Because the diffractive features of the second area ODOB mirror the diffractive features of the first area ODOA across the axis collinear with the centerline AA, their arrangement and orientation is not further described.

As illustrated in FIG. 6B, in an example embodiment, the first and second areas ODOA, ODOB of the out-coupling diffractive optic ODO may each comprise three zones 114A, 114B, 114E, 116A, 116B, 116E. For example, the first and third zones 114A, 114E, 116A, 116E may comprise the diffractive features described with regard to the corresponding zones in FIG. 6A. The second zones 114B, 116B include diffractive features comprising generally diamond-shaped posts having two sides generally parallel with the diffractive features of the first zone 114A and two sides generally parallel with the diffractive features of the fifth zone 114E.

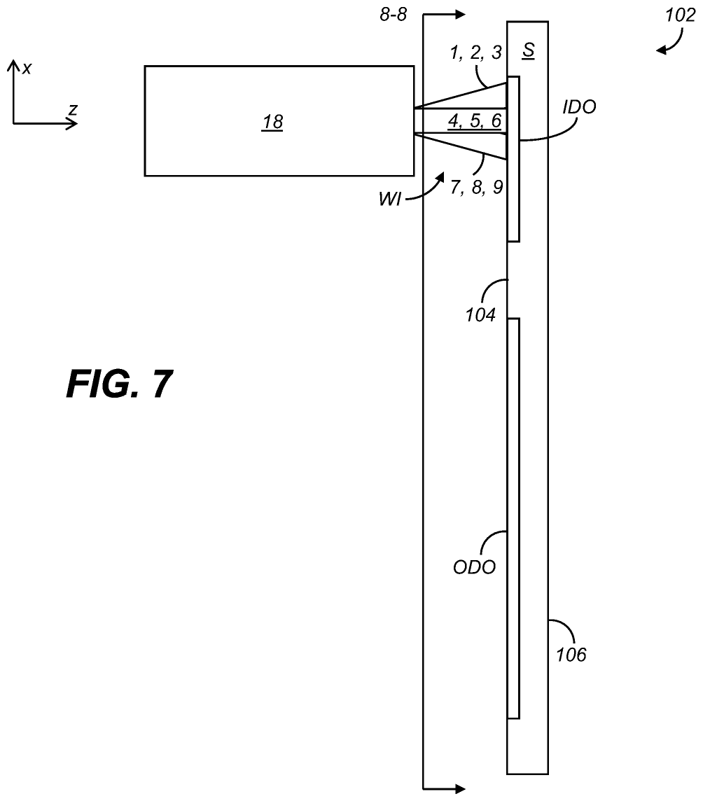

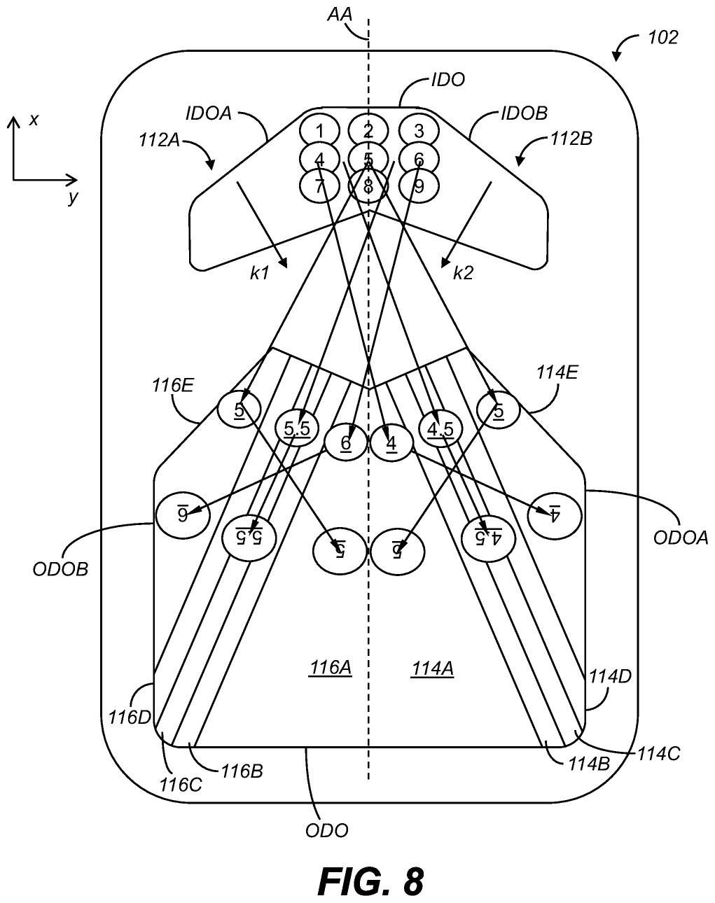

As illustrated in FIG. 7, image-bearing light WI from the image source 18 comprises a plurality of ray bundles 1, 2, 3, 4, 5, 6, 7, 8, 9 that spread from an optical stop (e.g., integral with the image source 18) in accordance with the FOV and are incident upon the in-coupling diffractive optic IDO. It should be appreciated that ray bundles 1, 2, 3, 4, 5, 6, 7, 8, and 9, are representative of a subset of ray bundles of the total ray bundles emitted by image source 18. In other words, an image to be viewed from within the eyebox E can comprise at least the plurality of ray bundles 1, 2, 3, 4, 5, 6, 7, 8, 9. FIG. 8 schematically illustrates the propagation of ray bundles 4, 5, 6 within the waveguide 102 before being output to the eyebox E. As shown in FIG. 8, the ray bundles 4, 5, 6, comprise a portion of the image emitted by the image source 18, where the portion of the image is flipped in the x-axis and y-axis directions when the ray bundles 4, 5, 6, are turned and out-coupled by the out-coupling diffractive optic ODO. In the example embodiment illustrated in FIG. 8, a portion of ray bundle 5 contacts and engages with a portion of the diffractive features 108 of the portion 112A of first zone IDOA. The diffractive features 108 are optimized to in-couple this portion of ray bundle 5 and direct that in-coupled light toward fifth zone 114E of out-coupling optic first area ODOA. The diffractive features of fifth zone 114E (having a grating vector k4), are optimized to turn the light associated with coupled portion of ray bundle 5, e.g., 45 degrees, causing that portion to propagate toward first zone 114A of out-coupling diffractive optic first area ODOA. The diffractive features of first zone 114A (having a grating vector k3) are optimized to out-couple that portion of ray bundle 5 out of the waveguide.

Similarly, at least a portion of the ray bundle 4.5 (e.g., representative of a ray bundle spatially between ray bundles 4 and 5) is in-coupled into the waveguide 102 by the diffractive features 108 (having a grating vector k1) of the first zone IDOA, where the diffractive features 108 are optimized to in-couple at least a portion of ray bundle 4.5 and the waveguide 102 propagates that light by TIR toward the second, third, and fourth zones 114B, 114C, 114D of the out-coupling diffractive optic first area ODOA. In some examples, the grating vectors of the diffractive features of second, third, and fourth zones 114B, 114C, 114D are optimized to diffract at least a portion (e.g., zero-order diffracted light) of the ray bundle 4.5 to another location within the second, third and fourth zones 114B, 114C, 114D generally along the original direction of propagation of the in-coupled ray bundle 4.5. Additionally, at least a portion of the ray bundle 4 is in-coupled into the waveguide 102 by the diffractive features 108 of the first zone IDOA and propagated to the first zone 114A of the out-coupling diffractive optic ODO. The diffractive features of first zone 114A (having a grating vector k3) are optimized to turn at least a portion of the ray bundle 4 incident upon the first zone 114A toward the fifth zone 114E. The diffractive features of the fifth zone 114E (having a grating vector k4) are optimized to diffract and out-couple at least a portion of the ray bundle 4 incident upon the fifth zone 114E toward the eyebox E upon odd numbered interactions of the ray bundle 4 with the diffractive features of the fifth zone 114E. It should be appreciated that a mirror of the foregoing light propagation can also occur with respect to ray bundles 5, 5.5, and 6 as they are in-coupled by second zone IDOB and are propagated and turned by zones 116A-116E of second area ODOB of out-coupling optic ODO.

In an example embodiment, the diffractive features of first zone IDOA of the in-coupling diffractive optic IDO are optimized to in-couple approximately a first half of the FOV from the single color band pico-projector 18 and the diffractive features of second zone IDOB of the in-coupling diffractive optic IDO are optimized to in-couple approximately the second half of the FOV from the single color band pico-projector 18. Because the angular bandwidth, and therefore the FOV, supported by the waveguide 102 is a function of the pitch of the diffractive features 108, 110 of the in-coupling diffractive optic IDO (as well as other factors such as, without limitation, TIR condition, thickness of the waveguide 102, angle of incidence, wavelength, and/or excessive angle), the FOV cannot be increased by changing the area or footprint of the in-coupling diffractive optic IDO alone. Therefore, optimizing each of the first and second zones IDOA, IDOB of the in-coupling diffractive optic IDO to support diffraction of image-bearing light corresponding to half the angular bandwidth of the total FOV enables the waveguide 102 to support a wide FOV without increasing the thickness of the waveguide 102 or changing other factors of the waveguide 102. In other words, each of the first and second zones IDOA, IDOB of the in-coupling diffractive optic IDO is operable to in-couple image-bearing light at the maximum angular bandwidth supported by the waveguide 102. It is possible for a projector 18 to produce a FOV that is too wide to couple effectively into a conventional waveguide. By utilizing the design disclosed herein, the waveguide 102 is configured to support a wide FOV (e.g., a FOV substantially double that supported by a conventional waveguide) without increasing the thickness of the waveguide 102 or changing other factors of the waveguide 102.

As shown in FIG. 8, it should be appreciated that the resulting image formed within the eyebox E and out-coupled by the out-coupling optic ODO, is mirrored or flipped over the axis colinear with the centerline AA and mirrored or flipped about a plane defined by the first surface 104 of the waveguide 102, with respect to the original image generated by the image source 18. In other words, the image is flipped upside-down and backwards with respect to the original image generated by the image source 18. For example, with respect to the first zone IDOA, light from ray bundle 5 is directed to fifth zone 114E of first area ODOA of out-coupling optic ODO where it is turned by the diffractive features of fifth zone 114E and directed toward first zone 114A, where it is out-coupled. By directing the light of ray bundle 5 to the opposite side of the out-coupling optic ODO, turning it toward the center line AA, and then out-coupling the light proximate the centerline AA, the image generated by that ray bundle is mirrored and flipped with respect to the orientation originally provided by the image source 18. Similar interactions occur with ray bundles 4 and 4.5 causing the entire half of the original FOV to be mirrored and flipped upon out-coupling by out-coupling optic ODO. Likewise, the original image generated by the image source 18 representative of the other half of the FOV is also flipped and mirrored before exiting the out-coupling optic ODO.

Although, in some examples, first zone IDOA is optimized to in-couple image-bearing light corresponding to approximately a first half of the FOV of the projector 18 and the second zone IDOB is optimized to in-couple image-bearing light corresponding to approximately a second half of the FOV of projector 18, it should be appreciated that the respective first and second zones IDOA, IDOB can be optimized to in-couple image-bearing light representative of more than half of the total FOV of the projector. For example, the first zone IDOA can be optimized for 60% of the FOV measured from a first side of the FOV of the projector 18 while the second zone IDOB can be optimized for 60% of the FOV measured from a second side of the FOV of the projector 18, with a 20% overlap. This is one non-limiting example; however, it should be appreciated that other amounts of overlap are acceptable, e.g., 10%, 15%, 20%, 25%, etc. In an example embodiment, first zone IDOA is optimized to in-couple image-bearing light corresponding to substantially a first half of the FOV of the projector 18 and the second zone IDOB is optimized to in-couple image-bearing light corresponding to substantially a second half of the FOV of projector 18, wherein substantially half of the FOV of the projector 18 is 50%-60% of the FOV.

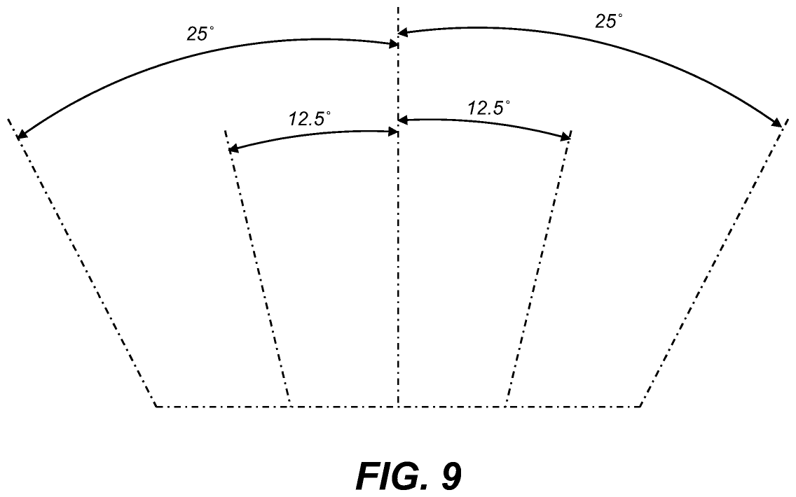

Referring now to FIG. 9, for example, the angular bandwidth of a wavelength of image-bearing light emitted by the image source 18 and in-coupled by the in-coupling diffractive optic IDO for TIR within the waveguide 102 to the out-coupling diffractive optic ODO is, without limitation, 25°. In an example embodiment, because the first zone IDOA of the in-coupling diffractive optic IDO is utilized to in-couple approximately the first half of the FOV, the center of the FOV in-coupled by the first zone IDOA is oriented at approximately (+12.5°) from the centerline of the total FOV. Similarly, the center of the FOV in-coupled by the second zone IDOB is oriented at approximately (−12.5°) from the centerline of the total FOV. As shown, the present arrangement is operable to double the effective angular bandwidth of the in-coupling and out-coupling diffractive optics IDO, ODO.

In addition to the advantage of doubling the effective angular bandwidth of the in-coupling and out-coupling diffractive optics IDO, ODO to increase the FOV to approximately, without limitation, 50°, the presently disclosed arrangement has the advantage of maintaining a small footprint of the waveguide 102 by utilizing a crossed optical path of the ray bundles from each half of the FOV. Further, the crossed optical path creates an out-coupling diffractive optic ODO that is effectively wider than its physical width.

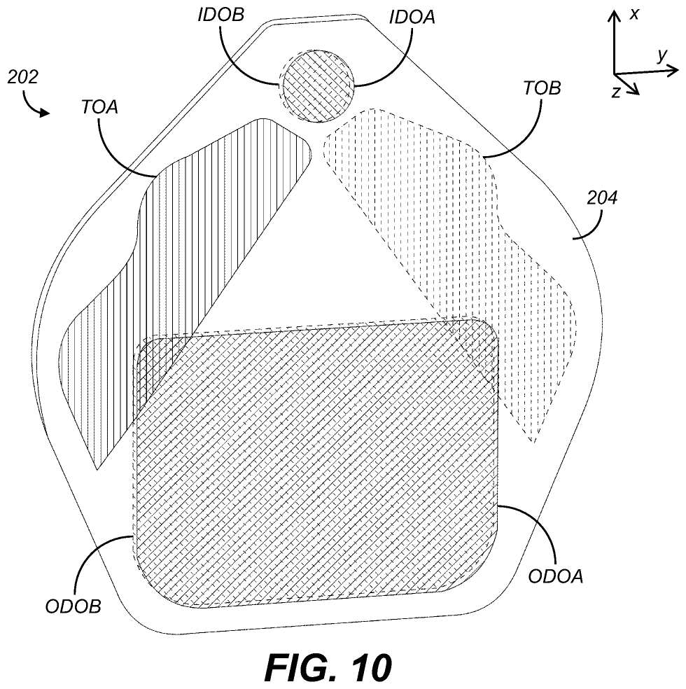

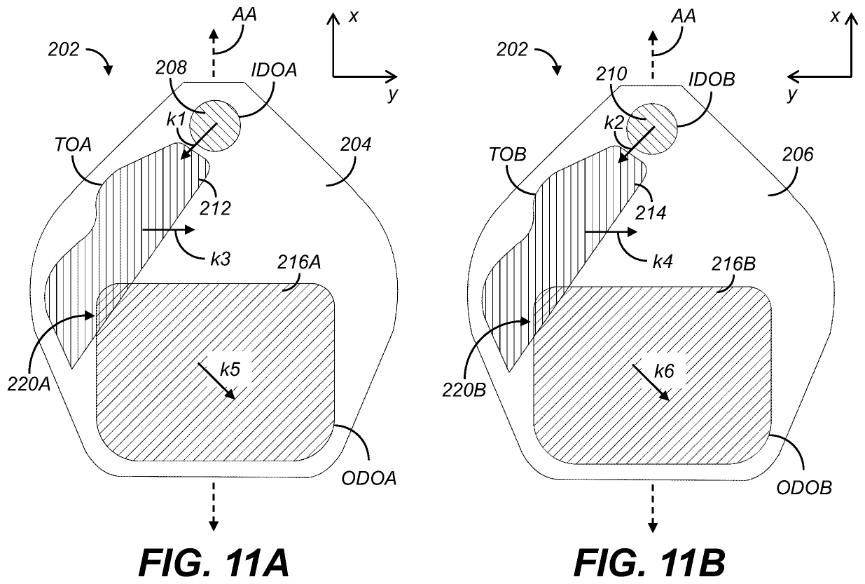

Referring now to FIGS. 10, 11A, and 111B, in an embodiment, a waveguide 202 includes an at least partially transparent substrate, which can be made of optical glass or plastic, with plane-parallel front and back surfaces 204, 206. The waveguide 202 includes a first in-coupling diffractive optic IDOA arranged on the front surface 204, and a second in-coupling diffractive optic IDOB arranged on the back surface 206. In an exemplary embodiment, the first in-coupling diffractive optic IDOA and the second in-coupling diffractive optic IDOB are coaxially arranged along an imaginary axis normal to the front and back surfaces 204, 206. The first in-coupling diffractive optic IDOA includes a first diffractive pattern 208 and the second in-coupling diffractive optic IDOB includes a second diffractive pattern 210. The first diffractive pattern 208 includes a plurality of diffractive features periodic in at least a first direction expressed by the grating vector k1. The second diffractive pattern 210 includes another plurality of diffractive features periodic in at least a second direction expressed by the grating vector k2. In an exemplary embodiment, the first diffractive pattern 208 is rotated eighty-degrees (80°) relative to the second diffractive pattern 210. In other words, the features of the first diffractive pattern 208 are arranged at an angle of eighty-degrees (80°) relative to the diffractive features of the second diffractive pattern 210. In another exemplary embodiment, the first diffractive pattern 208 is rotated at an angle less than or equal to ninety-degrees (90°) relative to the diffractive features of the second diffractive pattern 210.

In an exemplary embodiment, the coaxial (e.g., double-sided) design of the first and second in-coupling diffractive optics IDOA, IDOB is configured to diffract perpendicularly polarized portions of incident image-bearing light into the waveguide 202. For example, the first and second in-coupling diffractive optics IDOA, IDOB may be configured to in-couple a single wavelength range of light (e.g., green light between 495 nm-570 nm), and the first diffractive pattern 208 and the second diffractive pattern 210 may comprise blazed and/or slanted diffractive features.

The waveguide 202 also includes a first intermediate diffractive optic TOA arranged on the front surface 204, and a second intermediate diffractive optic TOB arranged on the back surface 206. The first intermediate diffractive optic TOA includes a diffractive pattern 212 and the second intermediate diffractive optic TOB includes a diffractive pattern 214. The diffractive pattern 212 includes a plurality of diffractive features periodic in at least one direction expressed by the grating vector k3. The diffractive pattern 214 includes another plurality of diffractive features periodic in at least one direction expressed by the grating vector k4. The intermediate diffractive optics TOA, TOB are operable to diffract light in-coupled by the respective in-coupling diffractive optics IDOA, IDOB to turn a portion of in-coupled image-bearing light toward out-coupling diffractive optics ODOA, ODOB. In an exemplary embodiment, the first and second intermediate diffractive optics TOA, TOB extend beyond the peripheral edge of the out-coupling diffractive optics ODOA, ODOB in the ±y-axis directions, respectively.

In an exemplary embodiment, the first out-coupling diffractive optic ODOA is arranged on the front surface 204 of the waveguide 202 and includes a plurality of diffractive features 216A periodic in at least one direction expressed by the grating vector k5. The second out-coupling diffractive optic ODOB is arranged on the back surface 206 of the waveguide 202 and includes a plurality of diffractive features 216B periodic in at least one direction expressed by the grating vector k6. In one or more exemplary embodiments, the first out-coupling diffractive optic ODOA and the second out-coupling diffractive optic ODOB are arranged on either the front or back surface 204, 206 as a crossed diffractive optic (e.g., a diffractive optic configured to expand the eyebox in at least two-dimensions). In an exemplary embodiment, a portion 220A of the first intermediate diffractive optic TOA overlaps a portion of the first out-coupling diffractive optic ODOA, and a portion 220B of the second intermediate diffractive optic TOB overlaps a portion of the second out-coupling diffractive optic ODOB.

In an exemplary embodiment, the first and second intermediate diffractive optics TOA, TOB may both be arranged on the front surface 204 of the waveguide 202, or both be arranged on the back surface 206 of the waveguide 202. Similarly, the first and second out-coupling diffractive optics ODOA, ODOB may both be arranged on the front surface 204 of the waveguide 202, or both be arranged on the back surface 206 of the waveguide 202.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An image light guide for conveying a virtual image, comprising:
a first surface and a parallel second surface;
an in-coupling diffractive optic arranged along the first surface and/or the second surface, wherein the in-coupling diffractive comprises a first zone having a first set of diffractive features and a second zone having a second set of diffractive features, and
an out-coupling diffractive optic arranged along the first surface and/or the second surface, wherein the out-coupling diffractive optic comprises a first area having two or more zones and a second area having two or more zones;
wherein an imaginary axis is oriented along a centerline of the out-coupling diffractive optic, and
wherein image-bearing light in-coupled into the waveguide by the first zone of the in-coupling diffractive optic is operable to propagate across the imaginary axis to the first area of the out-coupling diffractive optic, and wherein image-bearing light in-coupled into the waveguide by the second zone of the in-coupling diffractive optic is operable to propagate across the imaginary axis to the second area of the out-coupling diffractive optic.

2. The image light guide of claim 1, wherein the first zone of the in-coupling diffractive optic is operable to in-couple a first portion of a total field of view of an image, and the second zone of the in-coupling diffractive optic is operable to in-couple a second portion of the total field of view of the image.

3. The image light guide of claim 2, wherein the first zone of the in-coupling diffractive optic is optimized to in-couple image-bearing light having an incident angle representing a first portion of the total field of view of an image source.

4. The image light guide of claim 3, wherein the second zone of the in-coupling diffractive optic is optimized to in-couple image-bearing light having an incident angle representing a second half of the total field of view of an image source.

5. The image light guide of claim 2, wherein the first portion is substantially half of the total field of view, and the second portion is substantially half of the total field of view.

6. The image light guide of claim 2, wherein the first zone of the in-coupling diffractive optic is operable to in-couple image-bearing light at a maximum angular bandwidth supported by the image light guide; and the second zone of the in-coupling diffractive optic is operable to in-couple image-bearing light at the maximum angular bandwidth supported by the image light guide.

7. The image light guide of claim 1, wherein the first zone of the in-coupling diffractive optic is located on the first surface of the waveguide and the second zone of the in-coupling diffractive optic is located on the second surface of the waveguide.

8. The image light guide of claim 7, wherein the first area of the out-coupling diffractive optic is located on the first surface of the waveguide and the second area of the out-coupling diffractive optic is located on the second surface of the waveguide.

9. The image light guide of claim 1, wherein the first zone of the in-coupling diffractive optic has a first grating vector and the first area of the out-coupling diffractive optic includes at least one zone having a second grating vector, and wherein the first grating vector and the second grating vector are substantially equal in magnitude.

10. The image light guide of claim 1, wherein the first set of diffractive features of the first zone of the in-coupling diffractive optic at least partially overlap with the second set of diffractive features of the second area of the out-coupling diffractive optic.

11. The image light guide of claim 1, wherein the first zone of the in-coupling diffractive optic includes a laterally extending elongated portion operable to diffract a portion of image-bearing light in-coupled by the second zone of the in-coupling diffractive optic toward the original direction of propagation of the image-bearing light in-coupled by the second zone.

12. The image light guide of claim 1, wherein first area of the out-coupling diffractive optic comprises a first zone adjacent to the imaginary axis, a second zone adjacent to the first zone opposite the imaginary axis, and a third zone adjacent to the second zone opposite the first zone, wherein the second zone is oriented at an angle α relative to the imaginary axis.

13. The image light guide of claim 12, wherein image-bearing light incident on the third zone is directed to the first zone, image-bearing light incident on the second zone is directed to a second position within the second zone, and image-bearing light incident on the first zone is directed to the third zone.

14. An image light guide for conveying a virtual image, comprising:
a first surface and a parallel second surface;
an in-coupling diffractive optic arranged along the first surface and/or the second surface, wherein the in-coupling diffractive comprises a first zone having a first set of diffractive features and a second zone having a second set of diffractive features, and
an out-coupling diffractive optic arranged along the first surface and/or the second surface, wherein the out-coupling diffractive optic comprises a first area having two or more zones and a second area having two or more zones;
wherein image-bearing light in-coupled into the waveguide by the first zone of the in-coupling diffractive optic is operable to propagate across a path of image-bearing light in-coupled into the waveguide by the second zone of the in-coupling diffractive optic.

15. The image light guide of claim 14, wherein the image-bearing light in-coupled into the waveguide by the first zone of the in-coupling diffractive optic is incident on the first area of the out-coupling diffractive optic, and the image-bearing light in-coupled into the waveguide by the second zone of the in-coupling diffractive optic is incident on the second area of the out-coupling diffractive optic.

16. The image light guide of claim 14, wherein the first zone of the in-coupling diffractive optic is operable to in-couple a first portion of a total field of view of an image, and the second zone of the in-coupling diffractive optic is operable to in-couple a second portion of the total field of view of the image.

17. The image light guide of claim 16, wherein the first zone of the in-coupling diffractive optic is optimized to in-couple image-bearing light having an incident angle representing a first portion of the total field of view of an image source.

18. The image light guide of claim 17, wherein the second zone of the in-coupling diffractive optic is optimized to in-couple image-bearing light having an incident angle representing a second half of the total field of view of an image source.

19. The image light guide of claim 16, wherein the first portion is substantially half of the total field of view, and the second portion is substantially half of the total field of view.

20. The image light guide of claim 16, wherein the first zone of the in-coupling diffractive optic is operable to in-couple image-bearing light at a maximum angular bandwidth supported by the image light guide; and the second zone of the in-coupling diffractive optic is operable to in-couple image-bearing light at the maximum angular bandwidth supported by the image light guide.

21. An image light guide for conveying a virtual image, comprising:
a first surface and a parallel second surface;
a first in-coupling diffractive optic arranged along the first surface;
a second in-coupling diffractive optic arranged along the second surface, wherein the first and second in-coupling diffractive optics are arranged coaxially along a normal to the first surface;
an out-coupling diffractive optic arranged along the first surface and/or the second surface, wherein the out-coupling diffractive optic is configured to diffract image-bearing light beams toward an eyebox;
a first intermediate diffractive optic arranged along the first surface and/or the second surface, wherein the first intermediate diffractive optic is arranged optically between the first in-coupling diffractive optic and the out-coupling diffractive optic, wherein a portion of the first intermediate diffractive optic overlaps a first portion of the out-coupling diffractive optic; and
a second intermediate diffractive optic arranged along the first surface and/or the second surface, wherein the second intermediate diffractive optic is arranged optically between the second in-coupling diffractive optic and the out-coupling diffractive optic, wherein a portion of the second intermediate diffractive optic overlaps a second portion of the out-coupling diffractive optic.

22. The image light guide of claim 21, wherein the out-coupling diffractive optic is configured to expand the eyebox in at least one dimension, and the first intermediate diffractive optic is configured to expand the eyebox in at least one dimension.

23. The image light guide of claim 21, wherein the out-coupling diffractive optic is configured to expand the eyebox in two-dimensions.

24. The image light guide of claim 21, wherein the first in-coupling diffractive optic comprises a first plurality of diffractive features and the second in-coupling diffractive optic comprises a second plurality of diffractive features, wherein the second plurality of diffractive features are rotated at an angle less than or equal to ninety-degrees relative to the first plurality of diffractive features.
